(19) United States
(12) Patent Application Publication
(10) Pub. No.: US 2019/0227527 A1
(43) Pub. Date: Jul. 25, 2019

(54) NUMERICAL CONTROL DEVICE AND NUMERICAL CONTROL SYSTEM

(71) Applicant: FANUC CORPORATION, Yamanashi (JP)

(72) Inventors: Akira KOIZUMI, Yamanashi-ken (JP); Hiroyuki KATAYA, Yamanashi-ken (JP)

(21) Appl. No.: 16/251,587

(22) Filed: Jan. 18, 2019

(30) Foreign Application Priority Data
Jan. 22, 2018 (JP) 2018-008246

(51) Int. Cl. G05B 19/414; G05B 19/409; G06F 1/16

(52) U.S. Cl. CPC G05B 19/414; G05B 19/409; G05B 2219/36137; G05B 2219/36159; G06F 1/1626

(57) ABSTRACT

A numerical control device that is integrated with a display unit or is separated from and connected with a display unit includes: a control board including a control processor configured to perform numerical control; and a slot configured to allow for selective insertion of either a graphic board provided with an image processor to control the display unit that is integrated with the numerical control device, or an interface board connected with a communication cable for communication with the display unit that is separated from and connected to the numerical control device.

### CROSS-REFERENCE TO RELATED APPLICATION

This application is based upon and claims the benefit of priority from Japanese Patent Application No. 2018-008246 filed on Jan. 22, 2018, the contents of which are incorporated herein by reference.

### BACKGROUND OF THE INVENTION

### Field of the Invention

The present invention relates to a numerical control device that is integrated with a display unit or is separated from a display unit as well as relating to a numerical control system including the numerical control device.

### Description of the Related Art

Japanese Laid-Open Patent Publication No. 2015-156139 discloses a display-equipped machine operation panel connected to a numerical control device by a communication line.

### SUMMARY OF THE INVENTION

In the technique of Japanese Laid-Open Patent Publication No. 2015-156139, the numerical control device is configured separately from the display unit, so that a communication controller for communicating with the display unit is provided in the numerical control device while a controller for controlling the display unit is provided on the display unit side. Apart from this, when the numerical control device is formed integrally with the display unit, a controller for controlling the display unit is provided inside the numerical control device. That is, the numerical control device when it is configured separately from the display unit and the numerical control device when it is integrated with the display unit have different configurations. Therefore, the numerical control device that is formed separately from the display unit and the numerical control device that is integrated with the display unit need to be separately developed and designed, which results in increase in man-hours.

The present invention has been devised to solve the above problem, it is therefore an object of the present invention to provide a numerical control device and a numerical control system which can suppress increase in man-hours in developing a numerical control device separated from a display unit and a numerical control device integrally formed with a display unit.

A first aspect of the present invention resides in a numerical control device that is integrated with a display unit or is separated from and connected with a display unit, comprising: a control board including a control processor configured to perform numerical control; and a slot configured to allow for selective insertion of either a graphic board provided with an image processor to control the display unit that is integrated with the numerical control device, or an interface board connected with a communication cable for communication with the display unit that is separated from and connected to the numerical control device.

A second aspect of the present invention resides in a numerical control system comprising: display units; and a numerical control device that is configured to be either integrated with the display unit or separated from and connected to the display unit. In this system, the numerical control device includes: a control board including a control processor configured to perform numerical control; and a slot configured to allow for selective insertion of either a first graphic board provided with an image processor to control the display unit that is integrated with the numerical control device, or a first interface board connected with a communication cable for communication with a second graphic board including an image processor configured to control the display unit that is separated from and connected to the numerical control device.

According to the present invention, in developing a numerical control device configured separately from a display unit and a numerical control device integrally formed with the display unit, it is possible to suppress increase in development man-hours.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of an integrated type numerical control device with a display, viewed from the rear side;

FIG. 2 is a view showing the integrated type numerical control device from which some of electronic boards are drawn out;

FIG. 3 is a perspective view of a separate type numerical control device and the display, viewed from the rear side;

FIG. 4 is a view showing the separate type numerical control device from which some of electronic boards are drawn out;

FIG. 5A is a schematic diagram showing a configuration of an integrated type numerical control device including a main board and a graphic board;

FIG. 5B is a schematic diagram showing a configuration of a separate type numerical control device including a main board and an interface board and a configuration of a display unit including a graphic board;

FIG. 6A is a schematic diagram showing a configuration of an integrated type numerical control device including a main board and a graphic board;

FIG. 6B is a schematic diagram showing a configuration of a separate type numerical control device including a main board and an interface board and a configuration of a display unit including a graphic board;

FIG. 7A is a schematic diagram showing a configuration of an integrated type numerical control device including a main board and a graphic board;

FIG. 7B is a schematic diagram showing a configuration of a separate type numerical control device including a main board and an interface board and a configuration of a display unit including a graphic board;

FIG. 8A is a schematic diagram showing a configuration of an integrated type numerical control device including a main board and a graphic board; and

FIG. 8B is a schematic diagram showing a configuration of a separate type numerical control device including a main board and an interface board and a configuration of a display unit including a graphic board.

### DESCRIPTION OF THE PREFERRED EMBODIMENTS

### First Embodiment

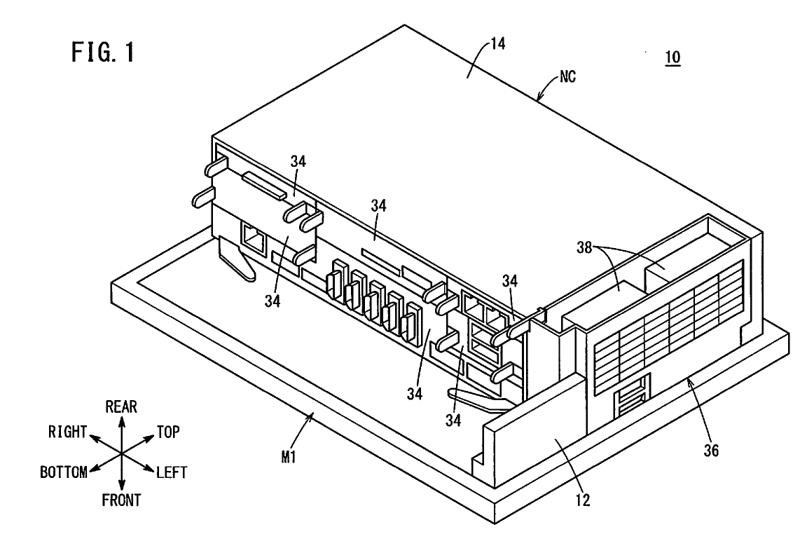

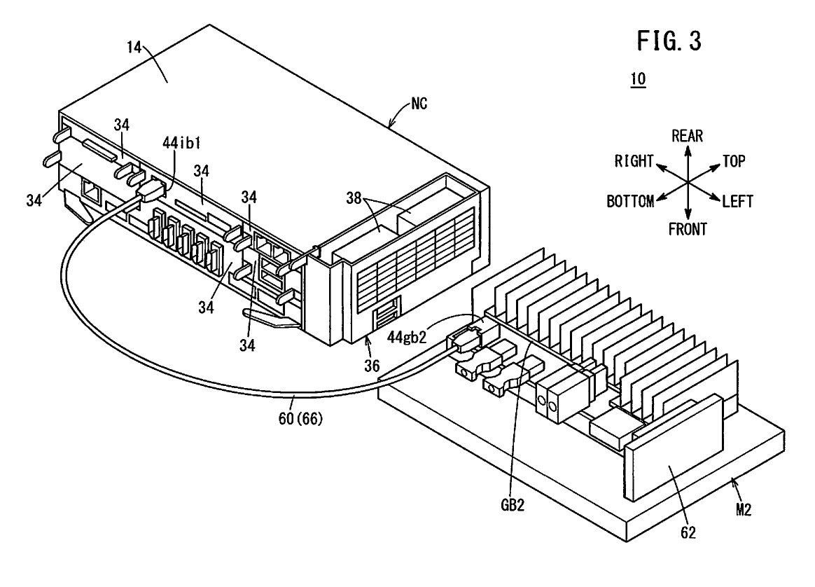

The numerical control device NC of the present embodiment is a control device that numerically controls a machine tool or the like. The numerical control device NC of the present embodiment has a configuration applicable to both an integrated type (or an all-in-one type, FIG. 1) that is integrated with (integrally connected with) a display unit M1 and a separate type (FIG. 3) that is configured separately from, and connected with, a display unit M2. The numerical control device NC forms a numerical control system 10 together with the display unit M1 or the display unit M2.

### [Configuration of Integral Numerical Control Device and Display Unit]

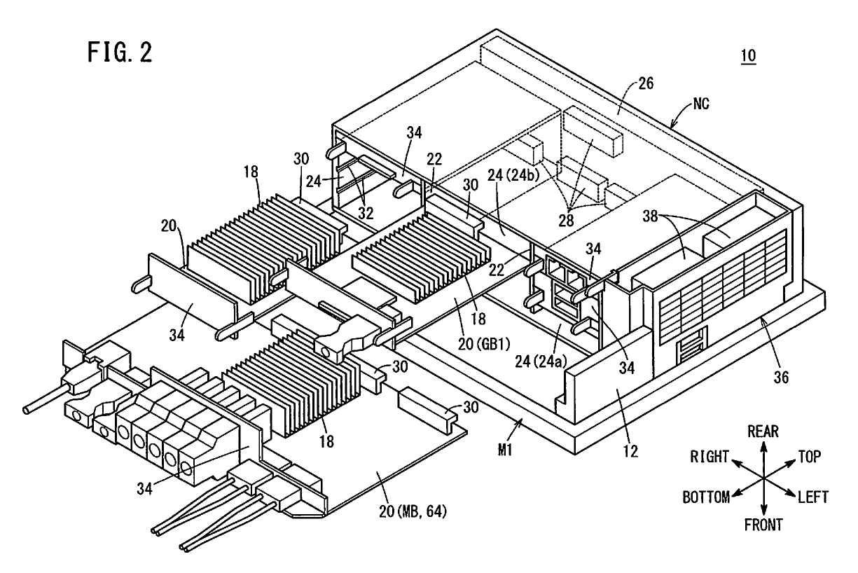

FIG. 1 is a perspective view of the integrated type numerical control device NC and the display unit M1, viewed from the rear side. FIG. 2 is a view showing a state in which some electronic boards 20 are drawn out from the integrated type numerical control device NC. As shown in FIG. 1, six directions, i.e., front, rear, top, bottom, left and right directions are defined, and in the following description the direction is described based on this definition.

The display unit M1 is a liquid crystal display, and a numerical control device NC is detachably attached to the upper position on the rear side of the display unit. Here, the display unit M1 is not limited to a liquid crystal display, but may be another display such as an organic electroluminescence display.

Further, an external slot 12 is detachably attached on the rear surface of the display unit M1 at the lower left of the numerical control device NC. The external slot 12 is a slot for receiving a USB, SD card, etc. and is provided so that a USB, SD card, etc. can be inserted from the front side of the display unit M1.

The numerical control device NC includes a housing 14 and a plurality of electronic boards 20, having various electronic components (parts) 18 provided thereon, and housed in the housing 14. The housing 14 has a box shape and a plurality of slots 24 formed therein by partition plates 22. Provided in the inner upper part of the housing 14 is a backboard 26. The backboard 26 has a plurality of connectors 28, to each of which a connector 30 formed on the upper part of each electronic board 20 is joined inside each slot 24. Grooved guides 32 extending in the vertical direction are arranged on both left and right sides of the slot 24. The guides 32 guide the electronic board 20 inserted in each slot 24 to the backboard 26. These guides 32 can position the electronic board 20 with respect to the front-back direction and the left-right direction.

A lid part 34 of a plate orthogonal to the electronic board 20 is provided under each electronic board 20. When the electronic board 20 is inserted into the slot 24, the opening of the slot 24 is closed by the lid part 34.

The numerical control device NC has a fan unit 36 in a position adjacent to the left side of the housing 14. The fan unit 36 is detachably attached to the housing 14. The fan unit 36 has a rear face opened so that a fan 38 can be attached from the rear side. The heat in the housing 14 is discharged to the outside by the fan 38 so as to cool the interior of the housing 14.

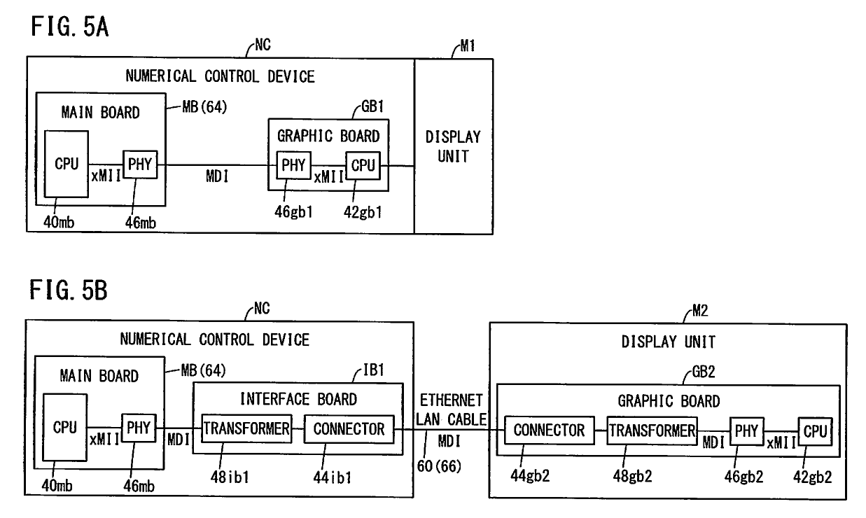

The integrated type numerical control device NC accommodates as the electronic boards 20 a main board MB (FIG. 5A) on which a control processor 40mb for numerical control is provided and a graphic board GB1 (FIG. 5A) on which an image processor 42gb1 for controlling the display unit M1 is provided. The main board MB has the largest area among the electronic boards 20 and is inserted into a slot 24a formed on the front side of the housing 14. The main board MB constitutes a control board 64. The graphic board GB1 is smaller in area than the main board MB and is inserted in slots 24b formed in the lateral center on the rear side of the housing 14. The main board MB and the graphic board GB1 can mutually communicate via the backboard 26. Also, the graphic board GB1 and the display unit M1 can communicate with each other via the backboard 26.

### [Configuration of Separate Type Control Device]

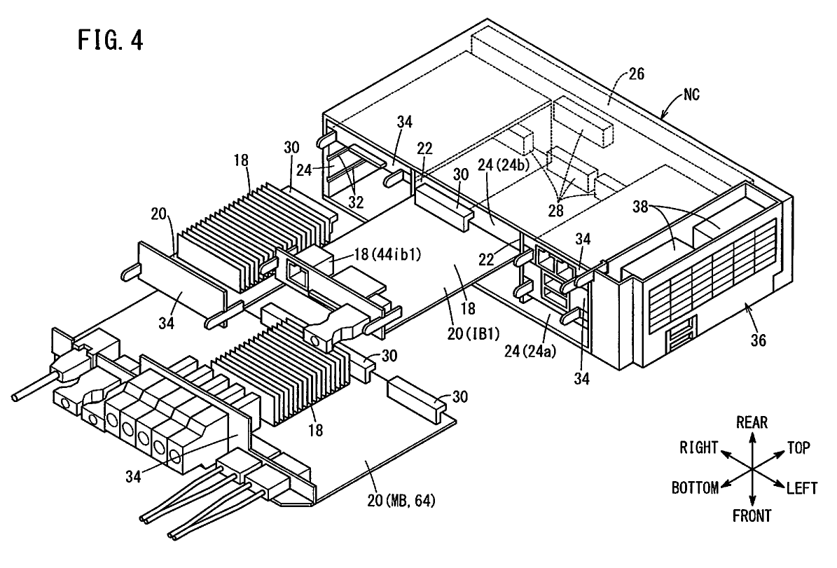

FIG. 3 is a perspective view of the separate type numerical control device NC and the display unit M2, viewed from the rear side. FIG. 4 is a view showing a state in which some the electronic boards 20 are drawn out from the numerical control device NC of the separate type. As shown in FIG. 3, six directions, i.e., front, rear, top, bottom, left and right directions (six directions) are defined, and in the following description, the direction is described based on this definition.

The separate type numerical control device NC is connected to the display unit M2 via an Ethernet (registered trademark) LAN cable 60. This Ethernet LAN cable 60 constitutes a communication cable 66. The display unit M2 is a liquid crystal display, has a graphic board GB2 arranged in the upper position on the rear side thereof. Here, the display unit M2 is not limited to a liquid crystal display, but may be another display such as an organic electroluminescence display.

Further, an external slot 62 is detachably attached on the rear surface of the display unit M2 in the lower left thereof. The external slot 62 is a slot for receiving a USB, SD card, etc. and is provided so that USB, SD card, etc. can be inserted from the front side of the display unit M2.

The structure of the separate type numerical control device NC is almost the same as that of the integrated type numerical control device NC, but is different in that an interface board IB1 is installed in the slot 24b, in which the graphic board GB1 is inserted in the integrated type numerical control device NC. The interface board IB1 has a connector 44ib1 into which the Ethernet LAN cable 60 for communication with the display unit M2 is plugged. The main board MB and the interface board IB1 can mutually communicate via the backboard 26. The interface board IB1 and the display unit M2 can mutually communicate via the Ethernet LAN cable 60.

### [Configuration of Electronic Boards]

FIG. 5A is a schematic diagram showing a configuration of the integrated type numerical control device NC including the main board MB and the graphic board GB1. FIG. 5B is a schematic diagram showing a configuration of the separate type numerical control device NC including the main board MB and the interface board IB1 and a configuration of the display unit M2 including the graphic board GB2.

The main board MB of the integrated type numerical control device NC and the main board MB of the separate type numerical control device NC are identical. Provided on the main board MB are the control processor 40mb which is a CPU for performing numerical control and a PHY (physical layer) chip 46mb which is a converter chip for performing conversion between digital logic signals and analog electric signals. The communication standard between the control processor 40mb and the PHY chip 46mb uses xMII. Here, the communication standard is not particularly limited to xMII as long as connection between the control processor 40mb as a device of the MAC layer, such as MII, GMII, RGMII, SGMII and the like and the PHY chip 46mb of the physical layer can be established.

Provided on the graphic board GB1 of the integrated type numerical control device NC are the image processor 42gb1 which is a CPU for controlling the display unit M1 and a PHY chip 46gb1.

The communication standard between the image processor 42gb1 and the PHY chip 46gb1 uses xMII. Here, MII, GMII, RGMII, SGMII and others may be used, not limited to xMII. In the integrated type numerical control device NC, MDI is used as the communication standard between the PHY chip 46mb (main board MB) and the PHY chip 46gb1 (graphic board GB1).

Provided on the interface board IB1 of the separate type numerical control device NC are a transformer 48ib1 which transmits electric pulse signals and provides functionality of electric insulation, and a connector 44ib1 to which the Ethernet LAN cable 60 is connected. MDI is used as the communication standard between the PHY chip 46mb (main board MB) and the transformer 48ib1 (interface board IB1) in the separate type numerical control device NC.

Provided on the graphic board GB2 of the display unit M2 are an image processor 42gb2 as a CPU for controlling the display unit M2, a PHY chip 46gb2, a transformer 48gb2, and a connector 44gb2. The communication standard between the image processor 42gb2 and the PHY chip 46gb2 uses xMII. Here, MII, GMII, RGMII, SGMII and others may be used, not limited to xMII. On the other hand, the communication standard between the PHY chip 46gb2 and the transformer 48gb2 uses MDI.

The separate type numerical control device NC and the display unit M2 are connected for communication with each other by plugging the Ethernet LAN cable 60 into each of the connector 44ib1 (numerical control device NC) of the interface board IB1 and the connector 44gb2 (display unit M2) of the graphic board GB2.

According to the numerical control device NC of the present embodiment, MDI is used as the communication standard between the main board MB and the graphic board GB1 in the integrated type numerical control device NC. Though MDI is usually used as a communication standard for Ethernet to connect devices by the communication cable, herein, MDI is used as the communication standard for communication between the main board MB and the graphic board GB1 connected in the numerical control device NC. This makes it possible to use the integrated type numerical control device NC as the separate type numerical control device NC by simply replacing the graphic board GB1 with the interface board IB1 to which the Ethernet LAN cable 60 is connected.

### [Operation and Effect]

The integrated type numerical control device NC connected integrally with the display unit M1 needs to have the image processor 42gb1 for controlling the display unit M1. On the other hand, the separate type numerical control device NC that is separated from and connected to the display unit M2 needs to have the connector 44gb2 and the transformer 48gb2 for communicating with the display unit M2. Since the integrated type numerical control device NC and the separate type numerical control device NC are different in configuration, development has to be carried out separately, which leads to increase in man-hours.

To deal with this, in the numerical control device NC according to the present embodiment, the image processor 42gb1 is provided on the graphic board GB1, which is an electronic board 20 separated from the main board MB. Also, the connector 44ib2 and the transformer 48ib1 are provided on the interface board IB1 which is another electronic board 20 separated from the main board MB. Further, the numerical control device NC according to the present embodiment uses a common communication standard for that between the main board MB and the graphic board GB1 and that between the main board MB and the interface board IB1, and is configured to have the slot 24b that allows one of the graphic boards GB1 and the interface boards IB1 to be selectively inserted. Thus, by simply changing the graphic board GB1 and the interface board IB1, it is possible to configure the integrated type numerical control device NC and the separate type numerical control device NC, hence develop the integrated type numerical control device NC and the separate type numerical control device NC in common, so that development man-hours can be suppressed. Further, it is possible to share most parts between the integrated type numerical control device NC and the separate type numerical control device NC.

Further, in the numerical control device NC according to the present embodiment, the control processor 40mb and the PHY chip 46mb are provided on the main board MB, the image processor 42gb1 and the PHY chip 46gb1 are provided on the graphic board GB1, and the transformer 48ib1 and the connector 44ib1 are provided on the interface board IB1. Thereby, it is possible to use the main board MB in common for both the integrated type numerical control device NC and the separate type numerical control device NC.

### Second Embodiment

In the numerical control device NC of the first embodiment, the transformer 48ib1 is provided on the interface board IB1. However, in the numerical control device NC of this embodiment, a transformer 48mb is provided on a main board MB. The second embodiment is different from the first embodiment in the configurations of the main board MB and the interface board IB1.

### [Configuration of Electronic Boards]

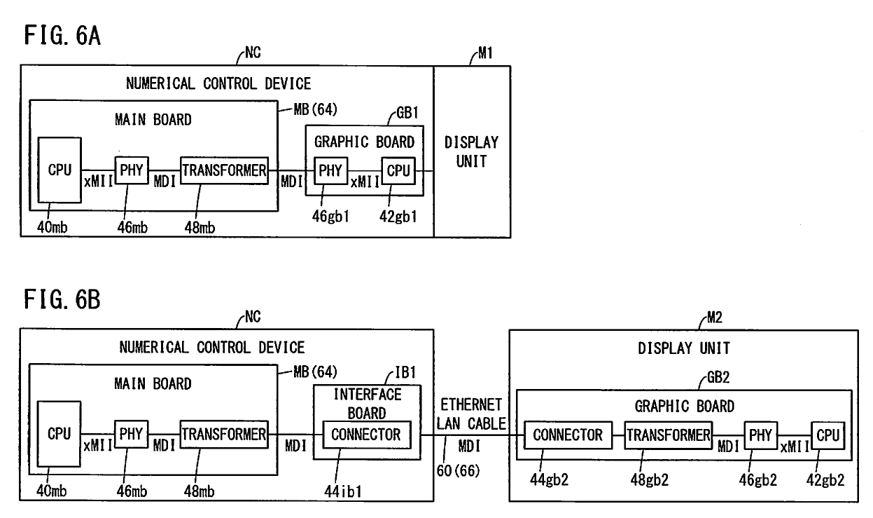

FIG. 6A is a schematic diagram showing a configuration of an integrated type numerical control device NC including a main board MB and a graphic board GB1. FIG. 6B is a schematic diagram showing a configuration of a separate type numerical control device NC including a main board MB and the interface board IB1 and a configuration of a display unit M2 including a graphic board GB2.

The main board MB of the integrated type numerical control device NC and the main board MB of the separate type numerical control device NC are identical. On the main board MB, the control processor 40mb and the PHY chip 46mb are provided. The main board MB further includes the transformer 48mb.

The communication standard between the control processor 40mb and the PHY chip 46mb uses xMII. Here, MII, GMII, RGMII, SGMII and others may be used, not limited to xMII. The communication standard between the PHY chip 46mb and the transformer 48mb uses MDI.

The graphic board GB1 of the integrated type numerical control device NC is the same as the graphic board GB1 of the integrated numerical control device NC of the first embodiment. In the integrated type numerical control device NC, MDI is used as the communication standard between the transformer 48mb (main board MB) and the PHY chip 46gb1 (graphic board GB1).

The connector 44ib1 is provided on the interface board IB1 of the separate type numerical control device NC. MDI is used as the communication standard between the transformer 48mb (main board MB) and the connector 44ib1 (interface board IB1) in the separate type numerical control device NC.

The graphic board GB2 of the display unit M2 is the same as the graphic board GB2 of the display unit M2 of the first embodiment. The separate type numerical control device NC and the display unit M2 are connected for communication with each other by plugging the Ethernet LAN cable 60 into each of the connector 44ib1 (numerical control device NC) of the interface board IB1 and a connector 44gb2 (display unit M2) of the graphic board GB2.

### [Operation and Effect]

In the numerical control device NC of the present embodiment, the transformer 48mb is provided on the main board MB. Therefore, the interface board IB1 of the separate type numerical control device NC needs to have the connector 44ib1 only, so that the configuration of the interface board IB1 can be simplified.

### Third Embodiment

In the numerical control device NC of the first embodiment, the PHY chip 46mb is provided on the main board MB. However, in the numerical control device NC of the present embodiment, a PHY chip 46ib1 is provided on the interface board IB1. The third embodiment is different from the first embodiment in the configurations of the main board MB, the graphic board GB1, and the interface board IB1.

[Configuration of Electronic Boards]

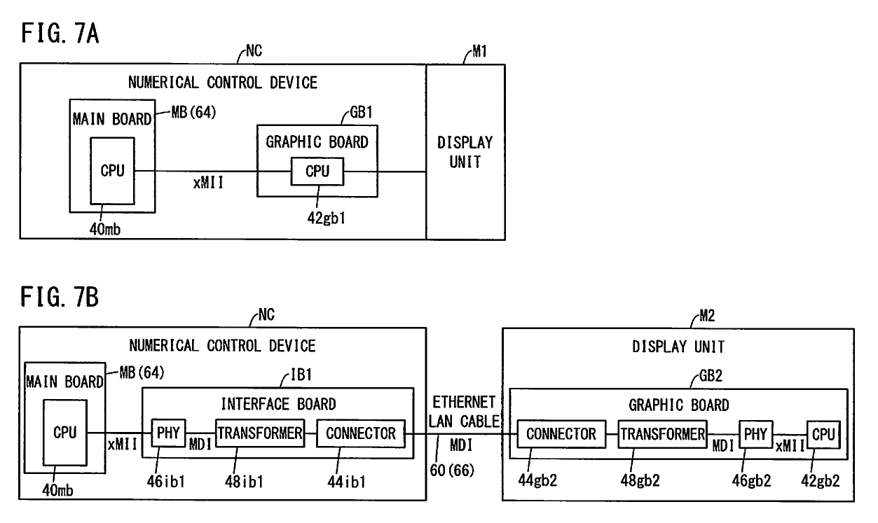

FIG. 7A is a schematic diagram showing a configuration of an integrated type numerical control device NC including a main board MB and a graphic board GB1. FIG. 7B is a schematic diagram showing a configuration of a separate type numerical control device NC including a main board MB and an interface board IB1 and a configuration of a display unit M2 including a graphic board GB2.

The main board MB of the integrated type numerical control device NC and the main board MB of the separate type numerical control device NC are identical. On the main board MB, the control processor 40mb is provided. The graphic board GB1 of the integrated type numerical control device NC has the image processor 42gb1 provided thereon. In the integral numerical control device NC, xMII is used as the communication standard between the control processor 40mb (main board MB) and the image processor 42gb1 (graphic board GB1). Here, MII, GMII, RGMII, SGMII and others may be used, not limited to xMII.

Provided on the interface board IB1 of the separate type numerical control device NC are the PHY chip 46ib1, the transformer 48ib1, and the connector 44ib1. MDI is used as a communication standard between the PHY chip 46ib1 and the transformer 48ib1. In the separate type numerical control device NC, xMII is used as the communication standard between the control processor 40mb (main board MB) and the PHY chip 46ib1 (interface board IB1). Here, MII, GMII, RGMII, SGMII and others may be used, not limited to xMII.

The graphic board GB2 of the display unit M2 is the same as the graphic board GB2 of the display unit M2 of the first embodiment. The separate type numerical control device NC and the display unit M2 are connected for communication with each other by plugging the Ethernet LAN cable 60 into each of the connector 44ib1 (numerical control device NC) of the interface board IB1 and the connector 44gb2 (display unit M2) of the graphic board GB2.

### [Operation and Effect]

In the numerical control device NC of the present embodiment, the PHY chip 46ib1 is provided on the interface board IB1. As a result, the control processor 40mb of the main board MB and the image processor 42gb1 of the graphic board GB1 can communicate directly, so that the configurations of the main board MB and the graphic board GB1 can be simplified.

### Fourth Embodiment

The integrated type numerical control device NC and the separate type numerical control device NC of the fourth embodiment have the same configurations as those in the first embodiment, but the separate type display unit M2 has a partially different configuration.

### [Configuration of Electronic Boards]

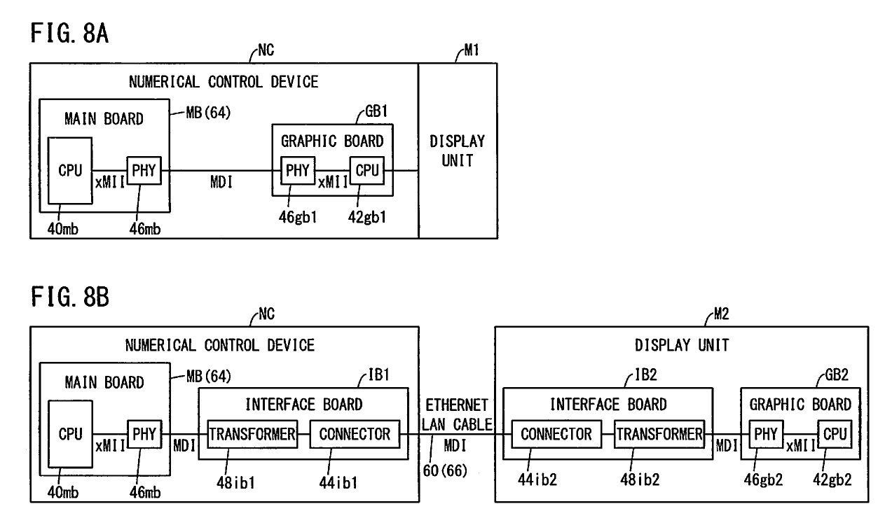

FIG. 8A is a schematic diagram showing a configuration of an integrated type numerical control device NC including a main board MB and a graphic board GB1. FIG. 8B is a schematic diagram showing a configuration of a separate type numerical control device NC including a main board MB and an interface board IB1 and a configuration of a display unit M2 having an interface board IB2 and a graphic board GB2.

The main board MB, the graphic board GB1 and the interface board IB1 of the numerical control device NC are the same as the main board MB, the graphic board GB1 and the interface board IB1 of the numerical control device NC of the first embodiment.

The display unit M2 has a graphic board GB2 and an interface board IB2. The graphic board GB2 is the same as the graphic board GB1 of the numerical control device NC, and an image processor 42gb2 and a PHY chip 46gb2 are provided. The interface board IB2 is the same as the interface board IB1 of the numerical control device NC, and a transformer 48ib2 and a connector 44ib2 are provided.

The separate type numerical control device NC and the display unit M2 are connected for communication with each other by plugging the Ethernet LAN cable 60 into each of the connector 44ib1 (numerical control device NC) of the interface board IB1 and the connector 44ib2 (display unit M2) of the interface board 132.

### [Operation and Effect]

In the present embodiment, the display unit M2 has the graphic board GB2 and the interface board IB2. As a result, the graphic board GB2 of the display unit M2 and the graphic board GB1 inserted into the integrated type numerical control device NC can be made common while the interface board IB2 of the display unit M2 and the interface board IB1 inserted into the separate type numerical control device NC can be made common.

[Technical Idea Obtained from Embodiment]

Technical ideas that can be grasped from the above embodiments will be described below.

The numerical control device (NC) that is integrated with the display unit (M1) or is separated from and connected with the display unit (M2) includes: the control board (64) including the control processor (40mb) configured to perform numerical control; and the slot (24b) configured to allow for selective insertion of either the graphic board (GB1) provided with the image processor (42gb1) to control the display unit (M1) that is integrated with the numerical control device (NC), or the interface board (IB1) connected with the communication cable (66) for communication with the display unit (M2) that is separated from and connected to the numerical control device (NC). This configuration makes it possible to configure the integrated type numerical control device (NC) and the separate type numerical control device (NC) merely by changing the graphic board (GB1) and the interface board (IB1), hence development of the integrated type numerical control device (NC) and development of the separate type numerical control device (NC) can be made common so that development man-hours can be suppressed. In addition, it is possible to share most parts between the integrated type numerical control device (NC) and the separate type numerical control device (NC).

In the above numerical control device (NC), the graphic board (GB1) may be inserted in the slot (24b). This makes it possible to configure the integrated type numerical control device (NC) simply by inserting the graphic board (GB1).

In the above numerical control device (NC), the interface board (IB1) may be inserted in the slot (24b). This makes it possible to constitute the separate numerical control device (NC) simply by inserting the interface board (IB1).

In the above numerical control device (NC), the communication standard between the graphic board (GB1) and the control board (64) and the communication standard between the interface board (IB1) and the control board (64) may be the same. Thereby, the configuration of the control board (64) can be made common for the integrated type numerical control device (NC) and the separate type numerical control device (NC).

The above numerical control device (NC) may be configured such that: the control board (64) includes the control processor (40mb) and the physical layer chip (46mb) configured to perform conversion between logic signals and electric signals; the graphic board (GB1) includes the physical layer chip (46gb1) and the image processor (42gb1); the interface board (IB1) includes the transformer (48ib1) configured to transmit pulse signals and provide electric insulation, and the connector (44ib1) configured to connect the communication cable (66); when the numerical control device (NC) is integrated with the display unit (M1), the graphic board (GB1) is inserted into the slot (24b) so that the physical layer chip (46mb) of the control board (64) and the physical layer chip (46gb1) of the graphic board (GB1) are connected; and when the numerical control device (NC) is separated from and connected to the display unit (M2), the interface board (IB1) is inserted into the slot (24b) so that the physical layer chip (46mb) of the control board (64) and the transformer (48ib1) of the interface board (IB1) are connected. Thereby, the control board (64) can be shared between the integrated type numerical control device (NC) and the separate type numerical control device (NC).

The above numerical control device (NC) can be configured such that: the control board (64) includes the control processor (40mb), the physical layer chip (46mb) configured to perform conversion between logic signals and electric signals and the transformer (48mb) configured to transmit pulse signals and provide electric insulation; the graphic board (GB1) includes the physical layer chip (46gb1) and the image processor (42gb1); the interface board (IB1) includes the connector (44ib1) configured to connect the communication cable (66); when the numerical control device (NC) is integrated with the display unit (M1), the graphic board (GB1) is inserted into the slot (24b) so that the transformer (48mb) of the control board (64) and the physical layer chip (46gb1) of the graphic board (GB1) are connected; and when the numerical control device (NC) is separated from and connected to the display unit (M2), the interface board (IB1) is inserted into the slot (24b) so that the transformer (48mb) of the control board (64) and the connector (44ib1) of the interface board (IB1) are connected. Therefore, the interface board (IB1) of the separate type numerical control device (NC) only needs to have the connector (44ib1), so that the configuration of the interface board (IB1) can be simplified.

The above numerical control device (NC) may be configured such that: the control board (64) includes the control processor (40mb); the graphic board (GB1) includes the image processor (42gb1); the interface board (IB1) includes the physical layer chip (46ib1) configured to perform conversion between logic signals and electric signals, the transformer (48ib1) configured to transmit pulse signals and provide electric insulation and the connector (44ib1) configured to connect the communication cable (66); when the numerical control device (NC) is integrated with the display unit (M1), the graphic board (GB1) is inserted into the slot (24b) so that the control processor (40mb) of the control board (64) and the image processor (42gb1) of the graphic board (GB1) are connected; and when the numerical control device (NC) is separated from and connected to the display unit (M2), the interface board (IB1) is inserted into the slot (24b) so that the control processor (40mb) of the control board (64) and the physical layer chip (46ib1) of the interface board (IB1) are connected. This enables the control processor (40mb) of the control board (64) and the image processor (42gb1) of the graphic board (GB1) to directly communicate with each other, and hence makes it possible to simplify the configurations of the main board (MB) and the graphic board (GB1).

The numerical control system (10) includes: display units (M1 and M2); and the numerical control device (NC) that is configured to be either integrated with the display unit (M1) or separated from and connected to the display unit (M2). In the system, the numerical control device (NC) includes: the control board (64) including the control processor (40mb) configured to perform numerical control; and the slot (24b) configured to allow for selective insertion of either the first graphic board (GB1) provided with the image processor (42gb1) to control the display unit (M1) that is integrated with the numerical control device (NC), or the first interface board (IB1) connected with the communication cable (66) for communication with the second graphic board (GB2) including the image processor (42gb2) configured to control the display unit (M2) that is separated from and connected to the numerical control device (NC). This configuration makes it possible to configure the integrated type numerical control device (NC) and the separate type numerical control device (NC) merely by changing the graphic board (GB1) and the interface board (IB1), hence development of the integrated type numerical control device (NC) and development of the separate type numerical control device (NC) can be made common so that development man-hours can be suppressed. In addition, it is possible to share most parts between the integrated type numerical control device (NC) and the separate type numerical control device (NC).

In the above numerical control system (10), the communication standard between the first graphic board (GB1) and the control board (64) and the communication standard between the first interface board (IB1) and the control board (64) may be the same. Thereby, the configuration of the control board (64) can be made common for the integrated type numerical control device (NC) and the separate type numerical control device (NC). The numerical control system (10) may be configured such that: the control board (64) includes the control processor (40mb) and the physical layer chip (46mb) configured to perform conversion between logic signals and electric signals; the first graphic board (GB1) includes the physical layer chip (46gb1) and the image processor (42gb1); the first interface board (IB1) includes the transformer (48ib1) configured to transmit pulse signals and provide electric insulation and the connector (44ib1) configured to connect the communication cable (66); the second graphic board (GB2) includes the connector (44gb2), the transformer (48gb2), the physical layer chip (46gb2) and the image processor (42gb2); when the numerical control device (NC) is integrated with the display unit (M1), the first graphic board (GB1) is inserted into the slot (24b) so that the physical layer chip (46mb) of the control board (64) and the physical layer chip (46gb1) of the first graphic board (GB1) are connected; and when the numerical control device (NC) is separated from and connected to the display unit (M2), the first interface board (IB1) is inserted into the slot (24b) so that the physical layer chip (46mb) of the control board (64) and the transformer (48ib1) of the first interface board (IB1) are connected while the connector (44ib1) of the first interface board (IB1) and the connector (44gb2) of the second graphic board (GB2) are connected by the communication cable (66). Thereby, the control board (64) can be shared between the integrated type numerical control device (NC) and the separate type numerical control device (NC).

The numerical control system (10) may be configured such that: the display unit (M2) that is separated from and connected with the numerical control device (NC) includes the second interface board (IB2) to be connected with the second graphic board (GB2); the control board (64) includes the control processor (40mb) and the physical layer chip (46mb) configured to perform conversion between logic signals and electric signals; the first graphic board (GB1) and the second graphic board (GB2) each include the physical layer chip (46gb1, 46gb2) and the image processor (42gb1, 42gb2); the first interface board (IB1) and the second interface board (IB2) each include the transformer (48ib1, 48ib2) configured to transmit pulse signals and provide electric insulation and the connector (44ib1, 44ib2) configured to connect the communication cable (66); when the numerical control device (NC) is integrated with the display unit (M1), the first graphic board (GB1) is inserted into the slot (24b) so that the physical layer chip (46mb) of the control board (64) and the physical layer chip (46gb1) of the first graphic board (GB1) are connected; and when the numerical control device (NC) is separated from and connected to the display unit (M2), the first interface board (IB1) is inserted into the slot (24b) so that the physical layer chip (46mb) of the control board (64) and the transformer (48ib1) of the first interface board (IB1) are connected while the physical layer chip (46gb2) of the second graphic board (GB2) and the transformer (48ib2) of the second interface board (IB2) are connected inside the display unit (M2), and the connector (44ib1) of the first interface board (IB1) and the connector (44ib2) of the second graphic board (GB2) are connected by the communication cable (66). As a result, the first graphic board (GB1) and the second graphic board (GB2) can be made common, and the first interface board (IB1) and the second interface board (IB2) can also be made common.

The numerical control system (10) may be configured such that: the control board (64) includes the control processor (40mb) and the physical layer chip (46mb) configured to perform conversion between logic signals and electric signals and the transformer (48mb) configured to transmit pulse signals and provide electric insulation; the first graphic board (GB1) includes the physical layer chip (46gb1) and the image processor (42gb1); the first interface board (IB1) includes the connector (44ib1) configured to connect the communication cable (66); the second graphic board (GB2) includes the connector (44gb2), the transformer (48gb2), the physical layer chip (46gb2) and the image processor (42gb2); when the numerical control device (NC) is integrated with the display unit (M1), the first graphic board (GB1) is inserted into the slot (24b) so that the transformer (48mb) of the control board (64) and the physical layer chip (46gb1) of the first graphic board (GB1) are connected; and when the numerical control device (NC) is separated from and connected to the display unit (M2), the first interface board (IB1) is inserted into the slot (24b) so that the transformer (48mb) of the control board (64) and the connector (44ib1) of the first interface board (IB1) are connected while the connector (44ib1) of the first interface board (IB1) and the connector (44gb2) of the second graphic board (GB2) are connected by the communication cable (66). Therefore, the interface board (IB1) of the separate type numerical control device (NC) only needs to have the connector (44ib1), so that the configuration of the interface board (IB1) can be simplified.

The numerical control system (10) may be configured such that: the control board (64) includes the control processor (40mb); the first graphic board (GB1) includes the image processor (42gb1); the first interface board (IB1) includes the physical layer chip (46ib1) configured to perform conversion between logic signals and electric signals, the transformer (48ib1) configured to transmit pulse signals and provide electric insulation and the connector (44ib1) configured to connect the communication cable (66); the second graphic board (GB2) includes the connector (44gb2), the transformer (48gb2), the physical layer chip (46gb2) and the image processor (42gb2); when the numerical control device (NC) is integrated with the display unit (M1), the first graphic board (GB1) is inserted into the slot (24b) so that the control processor (40mb) of the control board (64) and the image processor (42gb1) of the first graphic board (GB1) are connected; and when the numerical control device (NC) is separated from and connected to the display unit (M2), the first interface board (IB1) is inserted into the slot (24b) so that the control processor (40mb) of the control board (64) and the physical layer chip (46ib1) of the first interface board (IB1) are connected while the connector (44ib1) of the first interface board (IB1) and the connector (44gb2) of the second graphic board (GB2) are connected by the communication cable (66). As a result, the control processor (40mb) of the control board (64) and the image processor (42gb1) of the graphic board (GB1) can directly communicate with each other and the main board (MB) and the graphic board (GB1) can be simplified.

The present invention is not limited to the embodiments described above, and it goes without saying that the embodiments can be freely modified within a range that does not deviate from the essence and gist of the present invention as set forth in the appended claims.

What is claimed is:

1. A numerical control device that is integrated with a display unit or is separated from and connected with a display unit, comprising:
a control board including a control processor configured to perform numerical control; and
a slot configured to allow for selective insertion of either a graphic board provided with an image processor to control the display unit that is integrated with the numerical control device, or an interface board connected with a communication cable for communication with the display unit that is separated from and connected to the numerical control device.

2. The numerical control device according to claim 1, wherein the graphic board is inserted in the slot.

3. The numerical control device according to claim 1, wherein the interface board is inserted in the slot.

4. The numerical control device according to claim 1, wherein a communication standard between the graphic board and the control board and a communication standard between the interface board and the control board are same.

5. The numerical control device according to claim 1, wherein:
the control board includes the control processor and a physical layer chip configured to perform conversion between logic signals and electric signals;
the graphic board includes a physical layer chip and the image processor;
the interface board includes a transformer configured to transmit pulse signals and provide electric insulation, and a connector configured to connect the communication cable;
when the numerical control device is integrated with the display unit, the graphic board is inserted into the slot so that the physical layer chip of the control board and the physical layer chip of the graphic board are connected; and
when the numerical control device is separated from and connected to the display unit, the interface board is inserted into the slot so that the physical layer chip of the control board and the transformer of the interface board are connected.

6. The numerical control device according to claim 1, wherein:
the control board includes the control processor, a physical layer chip configured to perform conversion between logic signals and electric signals, and a transformer configured to transmit pulse signals and provide electric insulation;
the graphic board includes a physical layer chip and the image processor;
the interface board includes a connector configured to connect the communication cable;
when the numerical control device is integrated with the display unit, the graphic board is inserted into the slot so that the transformer of the control board and the physical layer chip of the graphic board are connected; and
when the numerical control device is separated from and connected to the display unit, the interface board is inserted into the slot so that the transformer of the control board and the connector of the interface board are connected.

7. The numerical control device according to claim 1, wherein:
the control board includes the control processor;
the graphic board includes the image processor;
the interface board includes a physical layer chip configured to perform conversion between logic signals and electric signals, a transformer configured to transmit pulse signals and provide electric insulation, and a connector configured to connect the communication cable;
when the numerical control device is integrated with the display unit, the graphic board is inserted into the slot so that the control processor of the control board and the image processor of the graphic board are connected; and
when the numerical control device is separated from and connected to the display unit, the interface board is inserted into the slot so that the control processor of the control board and the physical layer chip of the interface board are connected.

8. A numerical control system comprising:
display units; and
a numerical control device that is configured to be either integrated with the display unit or separated from and connected to the display unit, wherein
the numerical control device includes:
a control board including a control processor configured to perform numerical control; and
a slot configured to allow for selective insertion of either a first graphic board provided with an image processor to control the display unit that is integrated with the numerical control device, or a first interface board connected with a communication cable for communication with a second graphic board including an image processor configured to control the display unit that is separated from and connected to the numerical control device.

9. The numerical control system according to claim 8, wherein a communication standard between the first graphic board and the control board and a communication standard between the first interface board and the control board are same.

10. The numerical control system according to claim 8, wherein:
the control board includes the control processor and a physical layer chip configured to perform conversion between logic signals and electric signals;
the first graphic board includes a physical layer chip and the image processor;
the first interface board includes a transformer configured to transmit pulse signals and provide electric insulation, and a connector configured to connect the communication cable;
the second graphic board includes a connector, a transformer, a physical layer chip and the image processor;
when the numerical control device is integrated with the display unit, the first graphic board is inserted into the slot so that the physical layer chip of the control board and the physical layer chip of the first graphic board are connected; and
when the numerical control device is separated from and connected to the display unit, the first interface board is inserted into the slot so that the physical layer chip of the control board and the transformer of the first interface board are connected while the connector of the first interface board and the connector of the second graphic board are connected by the communication cable.

11. The numerical control system according to claim 8, wherein:
the display unit that is separated from and connected with the numerical control device includes a second interface board to be connected with the second graphic board;
the control board includes the control processor and a physical layer chip configured to perform conversion between logic signals and electric signals;
the first graphic board and the second graphic board each include a physical layer chip and the image processor;
the first interface board and the second interface board each include a transformer configured to transmit pulse signals and provide electric insulation, and a connector configured to connect the communication cable;
when the numerical control device is integrated with the display unit, the first graphic board is inserted into the slot so that the physical layer chip of the control board and the physical layer chip of the first graphic board are connected; and
when the numerical control device is separated from and connected to the display unit, the first interface board is inserted into the slot so that the physical layer chip of the control board and the transformer of the first interface board are connected while the physical layer chip of the second graphic board and the transformer of the second interface board are connected inside the display unit, and the connector of the first interface board and the connector of the second graphic board are connected by the communication cable.

12. The numerical control system according to claim 8, wherein
the control board includes the control processor and a physical layer chip configured to perform conversion between logic signals and electric signals, and a transformer configured to transmit pulse signals and provide electric insulation;
the first graphic board includes a physical layer chip and the image processor;
the first interface board includes a connector configured to connect the communication cable;
the second graphic board includes a connector, a transformer, a physical layer chip, and the image processor;
when the numerical control device is integrated with the display unit, the first graphic board is inserted into the slot so that the transformer of the control board and the physical layer chip of the first graphic board are connected; and
when the numerical control device is separated from and connected to the display unit, the first interface board is inserted into the slot so that the transformer of the control board and the connector of the first interface board are connected while the connector of the first interface board and the connector of the second graphic board are connected by the communication cable.

13. The numerical control system according to claim 8, wherein:
the control board includes the control processor;
the first graphic board includes the image processor;
the first interface board includes a physical layer chip configured to perform conversion between logic signals and electric signals, a transformer configured to transmit pulse signals and provide electric insulation, and a connector configured to connect the communication cable;
the second graphic board includes a connector, a transformer, a physical layer chip and the image processor;
when the numerical control device is integrated with the display unit, the first graphic board is inserted into the slot so that the control processor of the control board and the image processor of the first graphic board are connected; and
when the numerical control device is separated from and connected to the display unit, the first interface board is inserted into the slot so that the control processor of the control board and the physical layer chip of the first interface board are connected while the connector of the first interface board and the connector of the second graphic board are connected by the communication cable.
